(19) United States
(12) Patent Application Publication
(10) Pub. No.: US 2010/0124944 A1
(43) Pub. Date: May 20, 2010

(54) MOBILE COMMUNICATIONS DEVICE WITH SLIDABLE AND PIVOTABLE SCREEN

(75) Inventor: Young S. KIM, Los Altos, CA (US)

Correspondence Address: Dorsey & Whitney LLP;Intellectual Property Department - SF, Columbia Center, 701 Fifth Avenue, Suite 6100, Seattle, WA, 98101-7043, US

(73) Assignee: Inno Design, Inc., Palo Alto, CA (US)

(21) Appl. No.: 12/271,917

(22) Filed: Nov. 16, 2008

(51) Int. Cl. H04M 1/00

(52) U.S. Cl. 455/566; 455/575.4

(57) ABSTRACT

A mobile communications device including a base section having a keypad, a cover section having a screen and a connector assembly for coupling the cover section to the base section. A hinge permits the cover section to pivot from a closed position overlying the base section to an open position inclined relative to the base section to expose the keypad and the screen. A pin and socket assembly permits the screen to pivot 180 degrees from a first position in which the screen can oppose the keypad when the cover section is in the closed position to a second position in which the screen can be exposed when the cover section is in the closed position. A guide and slot assembly permits the cover section to slide relative to the base section to expose a portion of the keypad.

### SCOPE OF THE INVENTION

The present invention relates generally to a mobile communications device and more particularly to a mobile communications device with a QWERTY keypad.

### BACKGROUND

In today's mobile society an increasingly large number of individuals carry mobile communication devices such as cell phones. Modem cell phones not only provide voice communication but are also useful for a variety of other tasks such as email, internet access, photography, video playback and computing. In most current cell phones the telephone keypad serves the dual purpose of dialing phone numbers and as the input for the other functions. As the electronics within mobile or cellular telephones become more capable and the tasks that can be undertaken on these phones become more complex, there is a need for a mobile communications device that can be configured for operation as a cellular phone and reconfigured for operation as a video player or computing device.

### SUMMARY OF THE INVENTION

A mobile communications device is provided and includes a substantially planar base section having an upper side provided with a keypad and a substantially planar cover section having a top side and a bottom side provided with a screen. A connector assembly couples the cover section to the base section and includes a hinge for permitting the cover section to pivot from a closed position overlying the base section to an open position inclined relative to the base section to expose the keypad and the screen, a pin and socket assembly for permitting the screen to pivot 180 degrees from a first position in which the screen can oppose the keypad when the cover section is in the closed position to a second position in which the screen can be exposed when the cover section is in the closed position, and a guide and slot assembly for permitting the cover section to slide relative to the base section when the screen is in the second position from the compact position to an extended position to expose a portion of the keypad on the base section.

### BRIEF DESCRIPTION OF THE DRAWINGS

The accompanying drawings, which are incorporated in and form a part of this specification, illustrate an embodiment of the invention and, together with the description, serve to explain the principles of the invention.

FIG. 1 is a perspective view of the mobile communications device of the present invention in a first closed configuration.

FIG. 2 is a front elevational view of the mobile communications device of FIG. 1 taken along the line 2-2 of FIG. 1.

FIG. 3 is a rear elevational view of the mobile communications device of FIG. 1 taken along the line 3-3 of FIG. 1.

FIG. 4 is a left side elevational view of the mobile communications device of FIG. 1 taken along the line 4-4 of FIG. 1.

FIG. 5 is a right side elevational view of the mobile communications device of FIG. 1 taken along the line 5-5 of FIG. 1.

FIG. 6 is a bottom plan view of the mobile communications device of FIG. 1 taken along the line 6-6 of FIG. 2.

FIG. 7 is a perspective view of the mobile communications device of FIG. 1 in a first operational configuration with the cover open.

FIG. 8 is a perspective view of the mobile communications device of FIG. 1 in a second operational configuration with the cover pivoted relative to the base to expose the screen and overlying the base.

FIG. 9 is a top plan view of the mobile communications device of FIG. 1 taken along the line 9-9 of FIG. 8.

FIG. 10 is a perspective view of the mobile communications device of FIG. 1 in a third operational configuration with the cover with exposed screen slid to an extended position relative to the base.

FIG. 11 is a rear elevational view of the mobile communications device of FIG. 1 taken along the line 11-11 of FIG. 10.

FIG. 12 is a perspective view of the mobile communications device of FIG. 1 exploded from it second operational configuration of FIG. 8.

### DESCRIPTION OF THE INVENTION

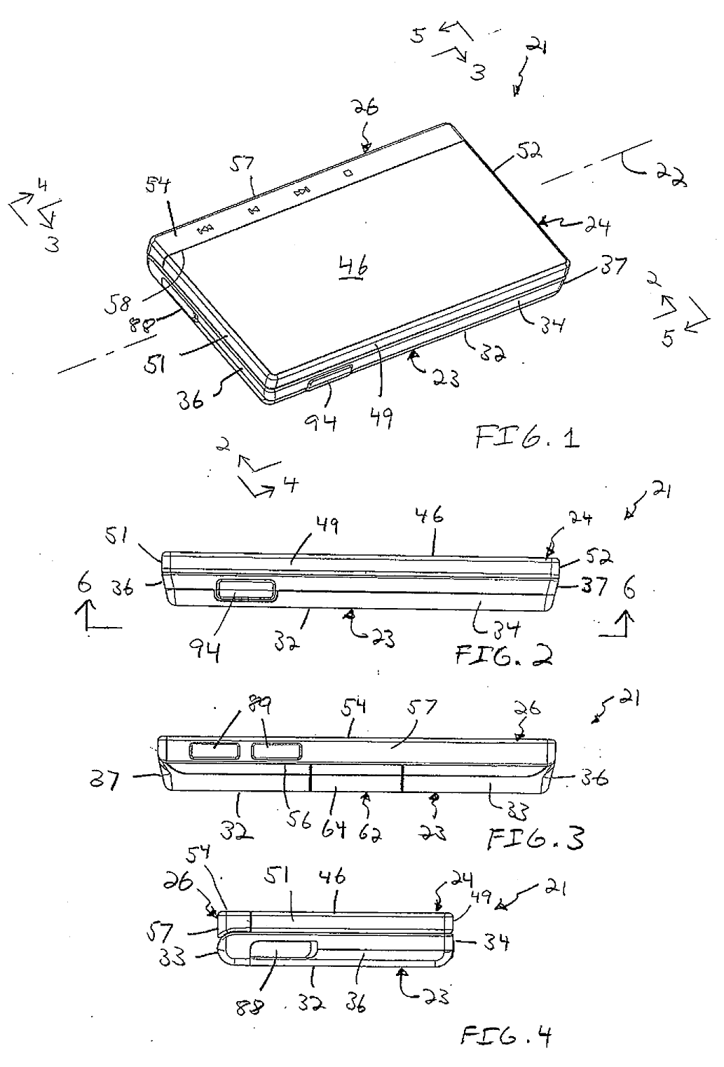

In general, mobile communication device 21 of the present invention, illustrated in FIGS. 1-12, can be a mobile or cellular telephone with a variety of other features. Device 21 is preferably compact in size and can have the shape of a parallelepiped. The elongate device extends along a longitudinal axis 22 and includes a base section or base 23, a cover section or cover 24 and a slideable element or slide 26 (see FIG. 1). In one embodiment, device 21 has a length of approximately 95 millimeters, a width of approximately 56 millimeters and a height of 13 millimeters.

Base 23 is a substantially planar body having an upper side 31 and an opposite lower side 32 extending parallel to each other, as well as a first or rear side 33 and a second or front side 34 extending between and substantially perpendicular of the upper and lower sides 31 and 32. Base 23 further includes a first or left end 36 and an opposite second or right end 37 extending between and substantially perpendicular of the upper and lower sides 31 and 32 and the rear and front sides 33 and 34. The upper side 31 of the base 23 is provided with a keypad 41, which in one embodiment is a QWERTY keypad (see FIG. 7). A portion of the keypad 41, for example the left side portion of the keypad, can be an alphanumerical keypad 42 that is aligned perpendicularly of the QWERTY keypad.

Cover 24 is a substantially planar body and includes a top side 46 and an opposite bottom side 47 extending parallel to each other. Cover 24 further includes a first or rear side 48 and an opposite second or front side 49 extending between and substantially perpendicular of the top and bottom sides 46 and 47, as well as a first or left end 51 and an opposite second or right end 52 extending between and substantially perpendicular of the top and bottom sides 46 and 47 and the rear and front sides 48 and 49. A conventional screen or display 53, such as a liquid crystal display or touch screen, is provided on the bottom side 47 of cover 24 (see FIG. 7). Screen 53 is preferably rectangular in shape and can be of any suitable size, preferable as large as possible, and in one embodiment occupies approximately two-thirds of the surface area of bottom side 47.

Elongate slide 26 has an upper side 54 and an opposite lower side 56, as well as a first or rear side 57 and second or front side 58 extending between and substantially perpendicular of the upper and lower sides 54 and 56. The slide 26 has a length approximating the length of base 23 and cover 24, a thickness approximating the thickness of cover 24 and a width approximating the difference between the width of base 23 and the width of cover 24 (see FIGS. 1, 4 and 5)

A connector assembly 61 of any suitable type is included within the device 21 for coupling cover 24 to base 23 (see FIG. 12). The elongate slide 26 is included within connector assembly 61. A hinge 62 and a guide and slot assembly 63 are additionally included within connector assembly 61 for pivotably and slidably coupling the slide 26 to base 23. The hinge 62 can be of any suitable type and in one embodiment is a partially cylindrical or hinge element 64 rotatably coupled to rear side 33 of base 23 for rotation about pivot axis 66 (see FIGS. 7 and 12). The hinge element 64 and base 23 include a suitable cooperative mating pivot assembly, such as a pin and socket arrangement (not shown), for permitting the cylindrical element to rotate relative to base 23. The hinge 62 is shown in FIG. 12 in a home position and shown in FIG. 7 in a rotated position.

The guide and slot assembly 63 permits slide 26 to slide longitudinally in a direction parallel to axis 22 relative to base 23. The guide and slot assembly 63 can include a guide element or guide 67 carried by rear side 33 of base 23 and extending outwardly from hinge element 64. In one embodiment, illustrated in FIGS. 11 and 12, the guide extends upwardly from the hinge element when the hinge 62 is in its home position. The lower side 56 of slide 26 is provided with an elongate slot 71 for slidable receiving guide 67 so as to permit the longitudinal movement of slide 26 relative to base 23. Guide 67 and slot 71 are cooperatively and properly sized and shaped so that the guide 67 cannot be withdrawn from the slot 71; slide 26 is thereby precluded from separating from hinge 62 during operation of device 21.

A pin and socket assembly 76 is included within connector assembly 61 for permitting cover 24 to pivot relative to slide 26 about a pivot axis 77 (see FIGS. 7 and 12). In one embodiment, the pin and socket assembly includes a pin element or pin 78 extending perpendicularly outwardly from rear side 48 of cover 24. A socket 79 is provided in front side 58 of slide 26 for pivotably receiving the pin 78. The pin 78 and socket 79 are cooperatively and properly sized and shaped manner so that the pin 78 cannot be withdrawn from the socket 79, and the pin 78 thereby precluded from removal from the socket 79 during operation of device 21.

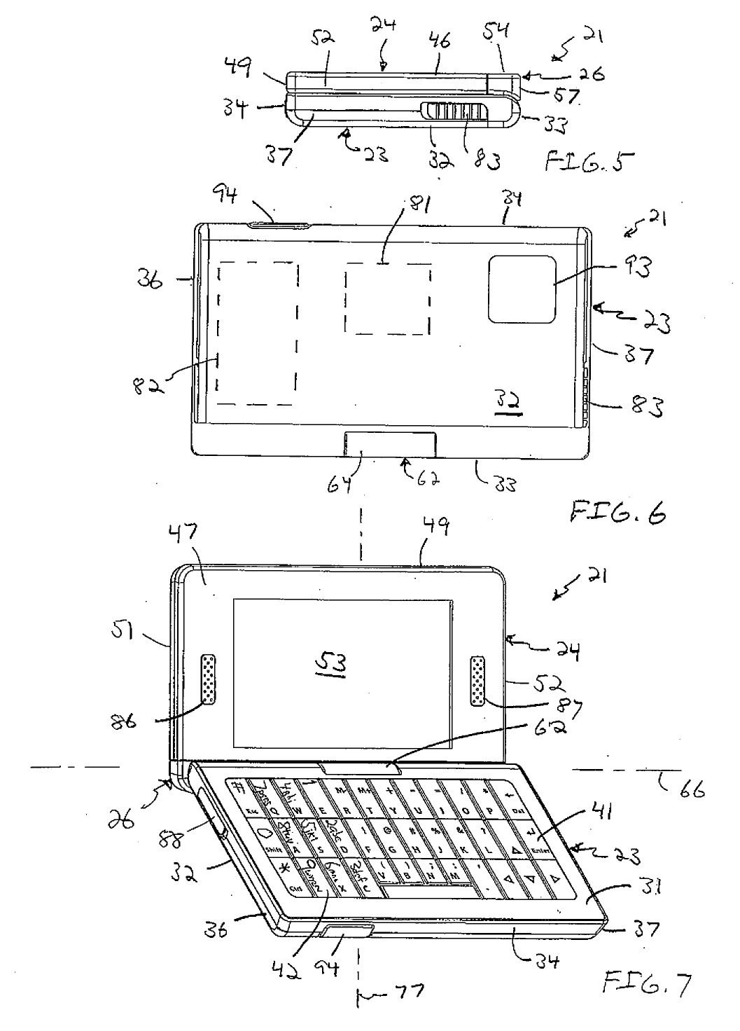

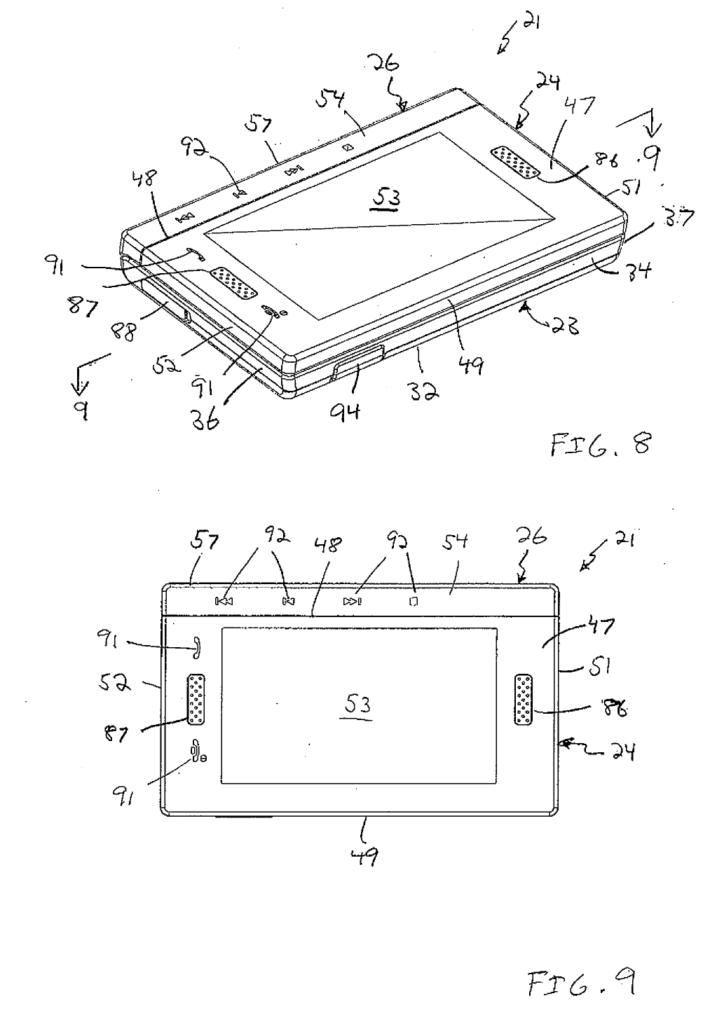

Control electronics 81, shows schematically in FIG. 6, are included within device 21 for controlling the function and features of the device and can include one or more microprocessors and other integrated circuits. A battery 82, accessible in a conventional manner for example through lower side 32 of base 23 by means of battery release 83, is included for powering the device 21. The battery release switch 83 can be provided on right end 37 of base 23 (see FIG. 5). In a conventional manner, electrical traces and leads extend from control electronics 81 to the various audio, visual and tactile components of the device 21. For example, electrical leads (not shown) can extend from the electronics 81 through hinge 62, guide and slot assembly 83 and pin and slot assembly 76 to electrically couple screen 53 to the electronics 81.

In operation and use, hinge 62 permits slide 26 and cover 24 carried by the slide to pivot about axis 66 from a closed position overlying base 23, as illustrated in FIG. 1, to an open position in which the cover 24 is inclined relative to base 23 so as to expose keypad 41 of the base 23 and screen 53 of the cover 24, as illustrated in FIG. 7. Although when in the open position cover 24 can be inclined or perpendicular to base 23, in one embodiment the cover 24 is inclined at an obtuse angle to the base 23 as shown in FIG. 7. In such an open position, QWERTY keypad 41 and screen 53 can be used so as to operate mobile communications device 21 for a variety of functions, including emailing, texting, personal computing, viewing video or other content stored on the device or accessible by the device through the internet or otherwise, listening to audio and performing other functions typically accomplished on a wireless personal computer, mobile communications device or personal digital assistant. At least one speaker 86 and at least one microphone 87 are included in device 21 for facilitating such operations. In one embodiment, speaker 86 and microphone 87 are provided on bottom side 47 of cover 24, speaker 86 being located between screen 53 and left end 51 and microphone 87 being located between screen 53 and right end 52. A communications jack 88 is provided on device 21 for optionally connecting the device to external speakers such as headphones or earbuds. In one embodiment, the communications jack is located on left end 36 of base 23 (see FIG. 1). To facilitate the receipt of audio communications over device 21, up and down volume control 89 can be provided on device 21 and in one embodiment are provided on rear side 57 of cover 24.

Pin and socket assembly 76 permits cover 24, and screen 53 carried by the cover, to pivot about axis 77 through an angle of approximately 180 degrees from a first position, illustrated in FIGS. 1 and 7, to a second position in which the screen is visible and exposed on the upper surface of the device 21 when cover 24 is moved to its closed position, as illustrated in FIGS. 8 and 9. More specifically, screen 53 opposes upper side 31 of base 23, and keypads 41 and 42 thereon, when the cover 24 is in its closed position and the screen is in its first position, as illustrated in FIG. 1. When screen 53 is in its second position and the cover 24 is in its closed position, as illustrated in FIGS. 8 and 9, device 21 can be utilized for a variety of functions, including to receive cellular telephone calls, to play back or view video stored on device 21 or accessible with the device through the internet or otherwise and to act as a camera. At least one and as shown a plurality of touch keys 91 are provided on bottom side 47 of cover 24 for operating device 21 as a cellular telephone when the device 21 is configured so that screen 53 is exposed on the upper surface of the device. In one embodiment, two touch keys 91 are provided adjacent microphone 87 for respectively receiving and terminating wireless communications such as telephone calls. At least one and preferably a plurality of touch keys 92 can be included on device 21 and accessible when cover 24 is closed and screen 53 in its second position for permitting operation of the device 21 as a video player. In one embodiment, a plurality of touch keys 92 are provided along upper side 54 of slide 26 and can include a playback key, a fast forward key, a reverse key and a stop key (see FIGS. 8 and 9). For permitting operations of device 21 as a camera, a conventional lens and underlying photo and video sensor 93 can be provided on lower side 32 of base 23 and a camera shutter button 94 provided on front side 34 of the base 23 for activating the sensor.

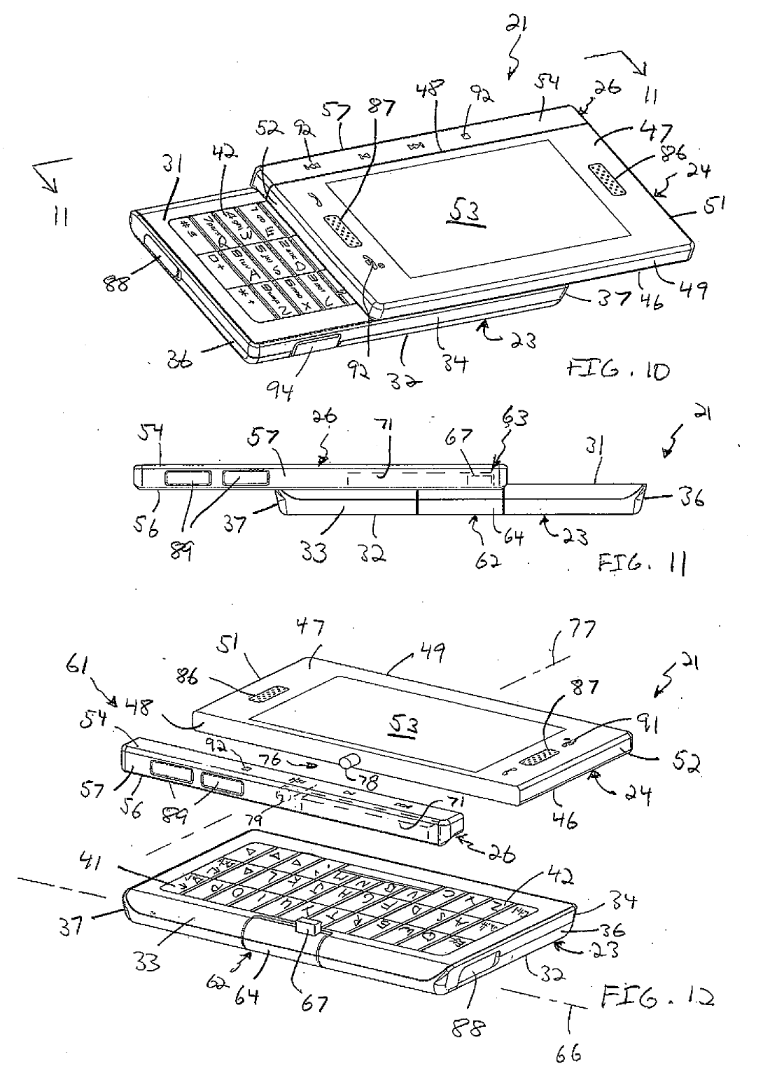

Guide and slot assembly 63 permits slide 26 and cover 24 carried by the slide to move longitudinally along axis 22 relative to base from a home or compact position shown in FIG. 1 to an extended position shown in FIGS. 10 and 11 for facilitating operation of device 21 as a cellular telephone or other mobile communications device. In one embodiment, the slide 26 is so operable when cover 24 is in its second position and in its closed position so that screen 53 is exposed on the upper surface of the device 21. In this regard, slot 71 is longitudinally sized as to permit slide 26 and cover 24 to slide longitudinally along base 23 a sufficient distance so as to expose a portion of keypad 41 and more specifically alphanumeric keypad 42. When device 21 is in such an extended position, the user can utilize the plurality of numbered and lettered keys in alphanumeric key pad 42 in a conventional manner, for example to instigate telephone calls and to send text messages.

It is appreciated that a second display or screen can be provided in device 21. For example, a display or screen (not shown) can be provided on top side 46 of cover 24, for example for visualizing information relating to incoming telephone calls, for permitting operation of device 21 as a camera when cover 24 is in its closed position and for a variety of other functions.

As can be seen from the foregoing, there has been provided a mobile communications device which in its closed position is relatively compact for travel. The cover of the device can be pivoted to an open position to reveal a screen and a QWERTY keypad for permitting use of the device as a fully functional computer or similar electronic device. When in its open position, the cover can be pivoted and then closed so that the screen is visible when the device is in its compact position. When so configured, the device can be utilized as a video player. When the screen is a touchpad, the screen can further serve as a alphanumeric keypad, a QWERTY keypad and any other conventional touchpad interface of a mobile communications device or personal digital assistance. The slidable screen in the device further enhances the functionality of the device by exposing a keypad, such as a alphanumeric keypad, so as to enhance the operation of the device.

Although the present invention has been described with reference to preferred embodiments, persons skilled in the art will recognize that changes may be made in form and detail without departing from the spirit and scope of the invention.

What is claimed is:

1. A mobile communications device comprising a substantially planar base section having an upper side provided with a keypad, a substantially planar cover section having a top side and a bottom side provided with a screen and a connector assembly for coupling the cover section to the base section, the connector assembly including a hinge for permitting the cover section to pivot from a closed position overlying the base section to an open position inclined relative to the base section to expose the keypad and the screen and a pin and socket assembly for permitting the screen to pivot 180 degrees from a first position in which the screen can oppose the keypad when the cover section is in the closed position to a second position in which the screen can be exposed when the cover section is in the closed position and a guide and slot assembly for permitting the cover section to slide relative to the base section when the screen is in the second position from the compact position to an extended position to expose a portion of the keypad on the base section.

2. The device of claim 1 wherein the connector assembly includes a slide element, the slide element being slidably coupled to the base section by the guide and slot assembly.

3. The device of claim 2 wherein the base section includes first and second sides, the upper side extending between the first and second sides and a portion of the guide and slot assembly being carried by the first side of the base section.

4. The device of claim 3 wherein the guide and slot assembly includes a guide carried by the base section and a slot provided in the slide element for slidably receiving the guide.

5. The device of claim 4 wherein the hinge is pivotably carried by the first side of the base section for pivoting the slide element relative to the base section.

6. The device of claim 5 wherein the guide extends outwardly from the hinge.

7. The device of claim 2 wherein the cover section is pivotably coupled to the slide element by the pin and socket assembly.

8. The device of claim 7 wherein the cover section includes first and second sides, the top side and the bottom side extending between the first and second sides and a portion of the pin and socket assembly being carried by the first side of the cover section.

9. The device of claim 8 wherein the pin and socket assembly includes a pin extending from the first side of the cover section and a socket provided in the slide element.

10. The device of claim 2 wherein the slide element includes controls for permitting operation as a video player when the cover section is in the closed position and the screen is in the second position.

11. The device of claim 1 wherein the keypad includes a QWERTY keypad for operation when the cover section is in the open position.

12. The device of claim 1 wherein the portion of the keypad includes an alphanumeric keypad.

13. The device of claim 1 wherein the bottom side of the cover section includes a microphone and a speaker for permitting communication when the cover section is in the closed position and the screen is in the second position.
